(19) United States
(12) Patent Application Publication
(10) Pub. No.: US 2025/0356396 A1
(43) Pub. Date: Nov. 20, 2025

(54) INFORMATION PROCESSING DEVICE, INFORMATION PROCESSING METHOD, AND PROGRAM

(71) Applicant: Sharp NEC Display Solutions, Ltd., Tokyo (JP)

(72) Inventor: Naoya KIMURA, Tokyo (JP)

(21) Appl. No.: 19/285,248

(22) Filed: Jul. 30, 2025

Related U.S. Application Data
(63) Continuation of application No. PCT/JP2023/002894, filed on Jan. 30, 2023.

(51) Int. Cl. G06Q 30/0272; G06F 3/16; G06Q 30/0207; G06V 40/16; G06V 40/18

(52) U.S. Cl. CPC G06Q 30/0272; G06F 3/167; G06Q 30/0207; G06V 40/161; G06V 40/18

(57) ABSTRACT

An information processing device includes an image capture capable of capturing an image of the face of a user looking at a display, an acquisitor acquiring a first advertisement with which one or more display termination conditions for terminating display of an advertisement are associated, a display controller causing the display to display the first advertisement acquired by the acquisitor, and a determiner determining whether or not at least one of the one or more display termination conditions has been satisfied on the basis of a captured image captured by the image capture when the first advertisement is displayed in the display. The display controller performs termination processing related to termination of displaying the first advertisement in the display when the determiner determines that at least one of the one or more display termination conditions has been satisfied.

### TECHNICAL FIELD

The present invention relates to an information processing device, an information processing method, and a program.

### BACKGROUND ART

Research and development is being conducted on technology of causing users to view advertisements displayed in information processing devices such as smartphones.

In this regard, an advertisement distribution system including an advertisement distribution device, a content display device, and an information processing terminal is known. The information processing terminal includes a display, and an image capture capable of capturing an image of the face of a user looking at a display screen of the display. The advertisement distribution device acquires a captured image captured by the image capture from the information processing terminal, detects a line of sight direction in which a line of sight of the user is directed on the basis of the acquired captured image, and determines which of the content display device and the information processing terminal an advertisement is to be distributed to on the basis of the detected line of sight direction (refer to Patent Document 1).

### CITATION LIST

### Patent Document

Patent Document 1: Japanese Unexamined Patent Application, First Publication No. 2018-125856

### SUMMARY OF INVENTION

### Technical Problem

However, in the advertisement distribution system described in Patent Document 1, there are cases in which users do not view advertisements distributed by the advertisement distribution device. This is undesirable because it is disadvantageous to advertisers distributing the advertisements.

The present invention has been made in consideration of such circumstances and aims to provide an information processing device, an information processing method, and a program capable of more reliably causing a user to view an advertisement displayed in a display.

### Solution to Problem

An information processing device according to an aspect of the present invention is an information processing device including an image capture capable of capturing an image of the face of a user looking at a display, an acquisitor acquiring a first advertisement with which one or more display termination conditions for terminating display of an advertisement are associated, a display controller causing the display to display the first advertisement acquired by the acquisitor, and a determiner determining whether or not at least one of the one or more display termination conditions has been satisfied on the basis of a captured image captured by the image capture when the first advertisement is displayed in the display. The display controller performs termination processing related to termination of displaying the first advertisement in the display when the determiner determines that at least one of the one or more display termination conditions has been satisfied.

An information processing method according to another aspect of the present invention is an information processing method for an information processing device including an image capture capable of capturing an image of the face of a user looking at a display. The method has an acquiring step of acquiring a first advertisement with which one or more display termination conditions for terminating display of an advertisement are associated, a display controlling step of causing the display to display the first advertisement acquired in the acquiring step, a determining step of determining whether or not at least one of the one or more display termination conditions has been satisfied on the basis of a captured image captured by the image capture when the first advertisement is displayed in the display, and a termination processing step of performing termination processing related to termination of displaying the first advertisement in the display when it is determined in the determining step that at least one of the one or more display termination conditions has been satisfied.

A program according to another aspect of the present invention causes a computer of an information processing device, which includes an image capture capable of capturing an image of the face of a user looking at a display, to execute an acquiring step of acquiring a first advertisement with which one or more display termination conditions for terminating display of an advertisement are associated, a display controlling step of causing the display to display the first advertisement acquired in the acquiring step, a determining step of determining whether or not at least one of the one or more display termination conditions has been satisfied on the basis of a captured image captured by the image capture when the first advertisement is displayed in the display, and a termination processing step of performing termination processing related to termination of displaying the first advertisement in the display when it is determined in the determining step that at least one of the one or more display termination conditions has been satisfied.

### Advantageous Effects of Invention

According to the present invention, it is possible to more reliably cause a user to view an advertisement displayed in a display.

### BRIEF DESCRIPTION OF DRAWINGS

FIG. 1 A view showing an example of a situation in which an information processing device 1 is used by a user U.

FIG. 2 A view showing an example of a hardware configuration of the information processing device 1.

FIG. 3 A view showing an example of a functional constitution of the information processing device 1.

FIG. 4 A view showing an example of a flow of processing in which the information processing device 1 causes a display 15 to display an advertisement.

FIG. 5 A view showing an example of a video image of a first advertisement displayed in the display 15 of the information processing device 1 through processing of Step S120 shown in FIG. 4.

FIG. 6 A view showing an example of a situation in which display of a mark XM has been deleted from a video image CM shown in FIG. 5.

FIG. 7 A view showing an example of a situation of the display 15 displaying a viewing promotion image.

FIG. 8 A view showing another example of a flow of the processing in which the information processing device 1 causes the display 15 to display an advertisement.

FIG. 9 A view showing an example of a flow of processing of changing the volume of audio when the information processing device 1 displays the first advertisement.

### DESCRIPTION OF EMBODIMENT

### Embodiment

Hereinafter, an embodiment of the present invention will be described with reference to the drawings.

### <Overview of Information Processing Device>

First, an overview of an information processing device according to the present embodiment will be described.

The information processing device according to the present embodiment includes an image capture, an acquisitor, a display controller, and a determiner. The image capture can capture an image of the face of a user looking at a display. The acquisitor acquires a first advertisement with which one or more display termination conditions for terminating viewing of an advertisement are associated. The display controller causes the display to display the first advertisement acquired by the acquisitor. The determiner determines whether or not at least one of the one or more display termination conditions has been satisfied on the basis of a captured image captured by the image capture when the first advertisement is displayed in the display. Further, the display controller performs termination processing related to termination of displaying the first advertisement in the display when the determiner determines that at least one of the one or more display termination conditions has been satisfied.

Accordingly, the information processing device according to the embodiment can more reliably cause a user to view an advertisement displayed in the display. As a result, the information processing device can satisfy both demand of advertisers who desire to reliably cause users to view their advertisements and demand of users who desire to shorten the time of viewing advertisements.

Hereinafter, a constitution of the information processing device according to the embodiment and processing performed by the information processing device will be described in detail.

### <Constitution of Information Processing Device>

Hereinafter, the constitution of the information processing device according to the embodiment will be described by taking an information processing device 1 as an example of the information processing device according to the embodiment. In the following description, for the sake of convenience of description, a user of the information processing device 1 will be referred to as a user U.

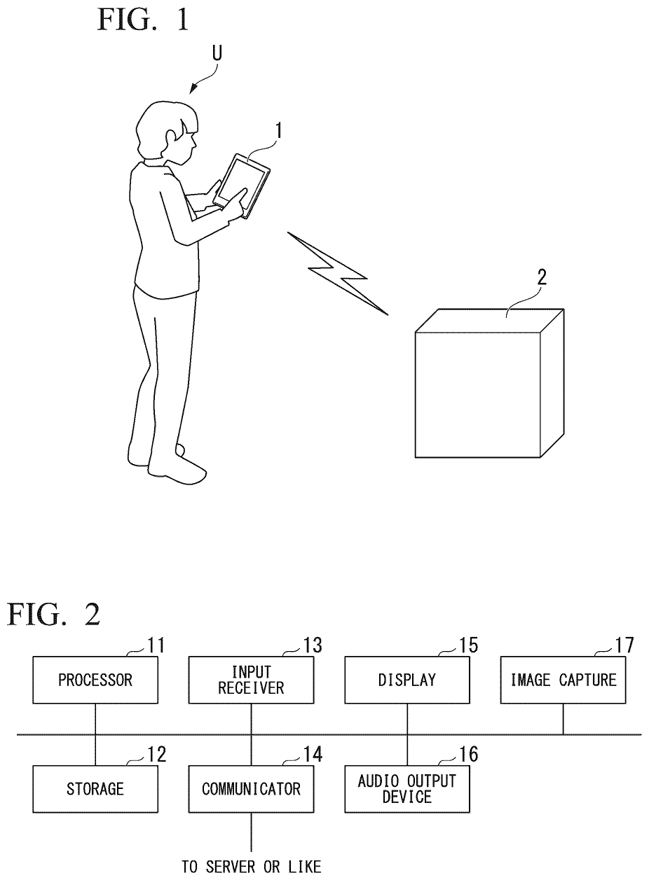

FIG. 1 is a view showing an example of a situation in which the information processing device 1 is used by the user U.

For example, the information processing device 1 is a multi-function mobile phone terminal (smartphone) capable of capturing an image of the face of the user U looking at a display screen of the information processing device 1. The information processing device 1 may be other information processing devices, such as a mobile phone terminal, a tablet personal computer (PC), a personal digital assistant (PDA), a notebook PC, a desktop PC, and the like, in place of a multi-function mobile phone terminal, as long as it is an information processing device capable of capturing an image of the face of the user U looking at the display screen of the information processing device 1.

The information processing device 1 executes an application program for providing various services to the user U in response to a received operation. The user U can play games, view video image contents, and read electronic books, for example, by executing such an application program using the information processing device 1.

Application programs executed by the information processing device 1 include application programs granting various rewards in exchange for viewing advertisements. In the following description, for the sake of convenience of description, such an application program will be referred to as a reward-granting application. Examples of rewards granted by a reward-granting application include points required to continue a games, points required to continue viewing video image contents, and points required to continue reading an electronic book, but they are not limited thereto. In addition, these points may be virtual coins or may be other kinds of rewards.

When an advertisement viewing start operation for starting viewing of an advertisement required to be granted a reward is received, the information processing device 1 acquires advertisement information from another server storing the advertisement information indicating the advertisement via a network. In the example shown in FIG. 1, the information processing device 1 acquires advertisement information from a server 2 via a network (not shown). The network connecting the information processing device 1 and the server 2 such that they can communicate with each other may be a mobile communication network, may be the Internet, or may be other kinds of networks.

Here, hereinafter, as an example, a case in which an advertisement is constituted of both a video image and audio will be described. Further, in the following description, for the sake of convenience of description, a video image constituting a certain advertisement will be referred to as a video image of the advertisement. In addition, in the following description, for the sake of convenience of description, audio constituting a certain advertisement will be referred to as audio of the advertisement. An advertisement may be constituted of only a video image, may be constituted of both a still image and audio, may be constituted of only a still image, or may be constituted of only audio.

In addition, one or more display termination conditions for terminating display of an advertisement are associated with an advertisement acquired by the information processing device 1 from the server 2. The one or more display termination conditions are conditions associated with an advertisement in advance according to an intention of an advertiser and are conditions allowing the advertiser, when at least one of them is satisfied, to acknowledge that the advertisement has been viewed. In other words, the one or more display termination conditions are conditions which can be assumed, when at least one of them is satisfied, to indicate that an advertisement has been viewed. Details of the one or more display termination conditions will be described below.

When advertisement information is acquired from the server 2, the information processing device 1 displays an advertisement indicated by the acquired advertisement information. In the case in which an advertisement is a video image accompanied by audio as in this example, when the information processing device 1 displays a certain advertisement, this means that the information processing device 1 displays the video image of the advertisement and outputs the audio of the advertisement. Here, in the following description, for the sake of convenience of description, the time length of the advertisement will be referred to as a display time of the advertisement. In this case, for example, the display time of an advertisement constituted of a 15-second long video image and audio is 15 seconds, which is the length of the video image and audio.

When an advertisement is displayed, the information processing device 1 captures an image of the face of the user U looking at the display screen of the information processing device 1. Thereafter, the information processing device 1 determines whether or not at least one of the one or more display termination conditions associated with the displayed advertisement has been satisfied on the basis of the captured image which has been captured. Further, when it is determined that at least one of the one or more display termination conditions has been satisfied, the information processing device 1 performs display termination processing related to termination of displaying the advertisement. Accordingly, the information processing device 1 can more reliably cause a user to view the displayed advertisement. The display termination processing is any of processing of terminating display of an advertisement, processing of displaying an image receiving an operation of terminating display of an advertisement, and processing of enabling an operation to be received in an image receiving an operation of terminating display of an advertisement. Details of the display termination processing will be described below.

### <Hardware Configuration of Information Processing Device>

Hereinafter, with reference to FIG. 2, a hardware configuration of the information processing device 1 will be described. FIG. 2 is a view showing an example of a hardware configuration of the information processing device 1.

For example, the information processing device 1 includes a processor 11, a storage 12, an input receiver 13, a communicator 14, a display 15, an audio output device 16, and an image capture 17. These constituent elements are connected such that they can communicate with each other via a bus. In addition, the information processing device 1 communicates with the server 2 and the like via the communicator 14.

For example, the processor 11 is a central processing unit (CPU). The processor 11 may be other processors such as a field programmable gate array (FPGA), in place of a CPU. The processor 11 executes various programs stored in the storage 12.

Examples of the storage 12 include a solid state drive (SSD), an electrically erasable programmable read only memory (EEPROM), a read only memory (ROM), and a random access memory (RAM). The storage 12 may be an external storage device connected through a digital input/output port such as a universal serial bus (USB), in place of that built into the information processing device 1. The storage 12 stores various information, various programs, various images, and the like processed by the information processing device 1.

For example, the input receiver 13 is a touch panel constituted integrally with the display 15. The input receiver 13 may be an input device such as a keyboard, a mouse, or a touch pad.

For example, the communicator 14 is constituted to include a digital input/output port for a USB or the like, an Ethernet (registered trademark) port, a communication antenna, and the like.

For example, the display 15 is a display device including a display panel, such as a liquid crystal display panel or an organic electroluminescence (EL) display panel, as the display screen of the information processing device 1.

The audio output device 16 is an audio output device including a speaker outputting audio.

For example, the image capture 17 is a camera including a charge coupled device (CCD), a complementary metal oxide semiconductor (CMOS), and the like as an image capturing element converting condensed light into electric signals. The image capture 17 is provided at a position in the information processing device 1 where an image of the face of the user U looking at the display screen of the display 15 can be captured. The image capture 17 may be constituted to capture a still image of a range of which an image can be captured by the image capture 17 or may be constituted to capture a video image within the range. Hereinafter, as an example, a case in which the image capture 17 captures a video image within the range will be described.

### <Functional Constitution of Information Processing Device>

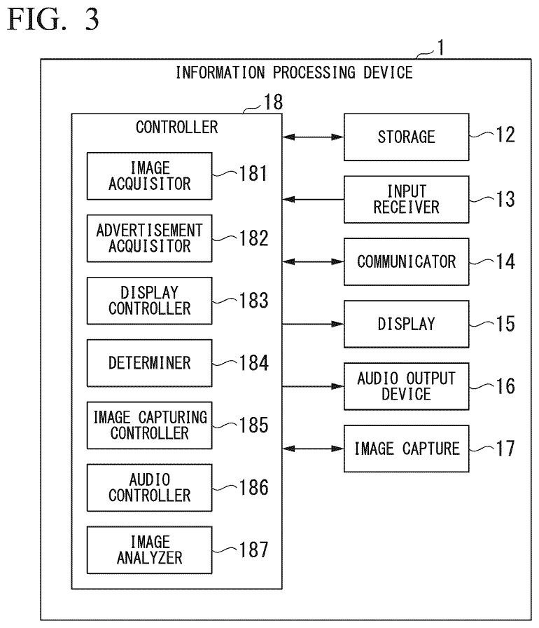

Hereinafter, with reference to FIG. 3, a functional constitution of the information processing device 1 will be described. FIG. 3 is a view showing an example of a functional constitution of the information processing device 1.

The information processing device 1 includes the storage 12, the input receiver 13, the communicator 14, the display 15, the audio output device 16, the image capture 17, and a controller 18.

The controller 18 controls the information processing device 1 in its entirety. The controller 18 includes an image acquisitor 181, an advertisement acquisitor 182, a display controller 183, a determiner 184, an image capturing controller 185, an audio controller 186, and an image analyzer 187. For example, these configurations included in the controller 18 are realized by the processor 11 executing various programs stored in the storage 12. In addition, some or all of the configurations may be hardware configurations including a large scale integration (LSI), an application specific integrated circuit (ASIC), and the like.

The image acquisitor 181 sequentially acquires frames of a video image captured by the image capture 17 as a captured image.

The advertisement acquisitor 182 acquires advertisement information from the server 2 via the communicator 14. The advertisement acquisitor 182 is an example of an acquisitor.

The display controller 183 generates various images to be displayed in the display 15. The display controller 183 causes the display 15 to display a generated image. In addition, the display controller 183 causes the display 15 to display a video image of an advertisement indicated by the advertisement information acquired by the advertisement acquisitor 182.

The determiner 184 performs various determination performed by the information processing device 1. Some or all of the functions of the determiner 184 may be constituents of the image analyzer 187.

The image capturing controller 185 controls the image capture 17.

The audio controller 186 causes the audio output device 16 to output audio. For example, the audio controller 186 causes the audio output device 16 to output audio of an advertisement indicated by the advertisement information acquired by the advertisement acquisitor 182. The audio controller 186 may be constituted integrally with the display controller 183.

The image analyzer 187 performs image analysis of a captured image acquired by the image acquisitor 181. For example, the image analyzer 187 detects the face of the user U on the basis of the captured image. In addition, for example, the image analyzer 187 detects a line of sight direction in which the line of sight of the user U is directed on the basis of the captured image. Some or all of the functions of the image analyzer 187 may be constituents of the determiner 184.

<Processing in which Information Processing Device Causes Display to Display Advertisement>

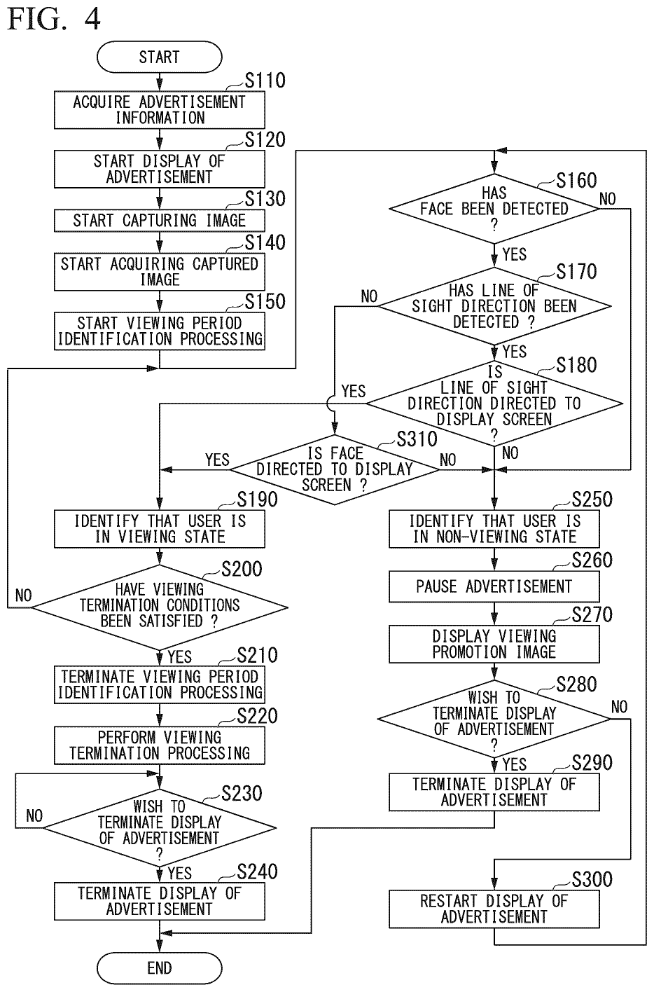

Hereinafter, with reference to FIG. 4, processing in which the information processing device 1 causes the display 15 to display an advertisement will be described. FIG. 4 is a view showing an example of a flow of processing in which the information processing device 1 causes the display 15 to display an advertisement. Hereinafter, as an example, a case in which the information processing device 1 has received the foregoing advertisement display start operation at a timing before the processing of Step S110 shown in FIG. 4 is performed will be described.

After the advertisement display start operation is received, the advertisement acquisitor 182 acquires advertisement information corresponding to the advertisement display start operation from the server 2 via the communicator 14 (Step S110).

Next, the display controller 183 and the audio controller 186 start display of an advertisement indicated by the advertisement information acquired by the advertisement acquisitor 182 in Step S110 (Step S120). More specifically, in Step S120, the display controller 183 causes the display 15 to start display of a video image of the advertisement. In addition, in Step S120, the audio controller 186 causes the audio output device 16 to start outputting of audio of the advertisement. In FIG. 4, the processing of Step S120 is indicated by “START DISPLAY OF ADVERTISEMENT”. In the following description, for the sake of convenience of description, an advertisement will be referred to as a first advertisement.

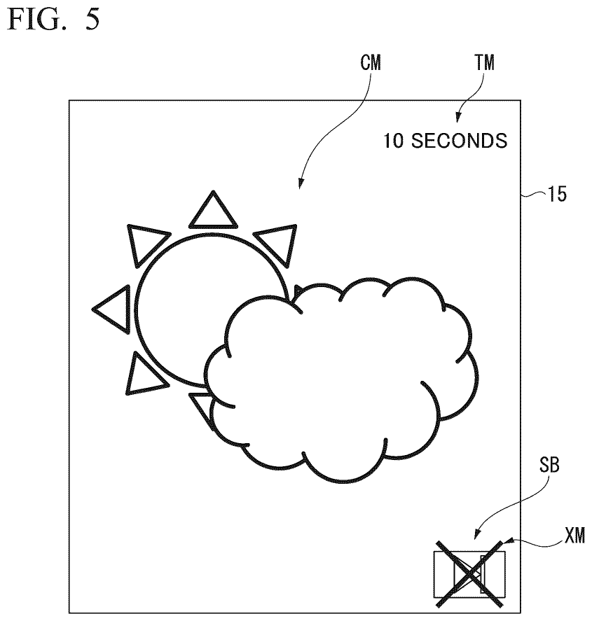

Here, FIG. 5 is a view showing an example of a video image of the first advertisement displayed in the display 15 of the information processing device 1 through the processing of Step S120 shown in FIG. 4. A video image CM shown in FIG. 5 is an example of a video image of the first advertisement. In addition, in the example shown in FIG. 5, the video image CM includes information TM and a button SB. The information TM indicates a remaining display time of the first advertisement. That is, for example, when the display time of the first advertisement is 15 seconds and 5 seconds have elapsed since display of the first advertisement has started, the information TM indicates the remaining 10 seconds as the remaining display time of the first advertisement. In the example, the information TM indicates that the remaining display time of the video image CM is “10 SECONDS”. The button SB is a button receiving an operation of terminating display of the first advertisement. In the example, a mark XM is superimposed on the button SB. When the mark XM is superimposed on the button SB, the information processing device 1 does not allow a selection operation (for example, tapping, clicking, or the like) to be performed in the button SB. That is, in this case, the user U cannot perform an operation of terminating display of the first advertisement in the information processing device 1. The mark XM is deleted from above the button SB when at least one of the foregoing one or more display termination conditions is satisfied. In other words, when at least one of the foregoing one or more display termination conditions is satisfied, the display controller 183 deletes display of the mark XM from above the button SB. Accordingly, the user U can perform a selection operation in the button SB.

Next, the image capturing controller 185 controls the image capture 17 to cause the image capture 17 to start capturing an image of a range of which an image can be captured by the image capture 17 (Step S130).

Next, the image acquisitor 181 starts acquiring frames of a video image captured by the image capture 17 from the image capture 17 every time a predetermined sampling cycle elapses. The processing of Step S130 and the processing of Step S140 may be performed in parallel or may be performed in the reverse order.

Next, the determiner 184 starts viewing period identification processing (Step S150). The viewing period identification processing is processing of identifying, as a viewing period, each of one or more periods during which the user U is viewing the first advertisement within the display time of the first advertisement. Specifically, in the viewing period identification processing, the determiner 184 determines whether the state of the user U is a viewing state and a non-viewing state within the display time. Here, the viewing state of the state of the user U is a state of viewing the first advertisement. In addition, the non-viewing state of the state of the user U is a state of not viewing the first advertisement. Further, the determiner 184 identifies, as a viewing period, each of one or more periods during which it has been determined that the state of the user U is the viewing state among the periods included in the display time. Meanwhile, the determiner 184 identifies, as a non-viewing period, each of one or more periods during which it has been determined that the state of the user U is the non-viewing state among the periods included in the display time. For example, when the display time of the first advertisement is 15 seconds, and when it is determined that the state of the user U is the viewing state in each of a period between a time point after zero seconds have elapsed from a timing when the first advertisement has started being displayed and a time point after 3 seconds have elapsed from the timing, and a period between a time point after 6 seconds have elapsed from the timing and a time point after 10 seconds have elapsed from the timing, the determiner 184 identifies these two periods as the viewing periods. In addition, for example, in this case, the determiner 184 identifies, as the non-viewing periods, periods other than these two periods among the periods included within the display time of the first advertisement. Instead of this, the method for identifying the viewing period and the non-viewing period may be other methods.

Next, the image analyzer 187 acquires a captured image, which has been acquired most recently among captured images acquired by the image acquisitor 181, as a target captured image which will become a target of image analysis. After the target captured image is acquired, the image analyzer 187 performs image analysis of detecting the face of the user U from the target captured image. Further, as a result of this image analysis, the image analyzer 187 determines whether or not the face of the user U has been detected from the target captured image (Step S160). The method for detecting the face of the user U from the target captured image by the image analyzer 187 may be a known method or may be a method to be developed in the future.

When it is determined that the face of the user U has been detected from the target captured image (Step S160—YES), the image analyzer 187 performs image analysis of detecting the line of sight direction in which the line of sight of the user U is directed from the target captured image. Further, as a result of this image analysis, the image analyzer 187 determines whether or not the line of sight direction has been detected (Step S170). The method for detecting the line of sight direction from the target captured image by the image analyzer 187 may be a known method or may be a method to be developed in the future.

When it is determined that the line of sight direction in which the line of sight of the user U is directed has been detected from the target captured image (Step S170—YES), the image analyzer 187 determines whether or not the line of sight direction is directed to the display screen of the display 15 (Step S180). The determination method for determining whether or not the line of sight direction is directed to the display screen using the image analyzer 187 may be a known method or may be a method to be developed in the future.

When it is determined that the line of sight direction in which the line of sight of the user U is directed has been directed to the display screen of the display 15 (Step S180—YES), the image analyzer 187 identifies that the state of the user U is the viewing state (Step S190). Accordingly, the determiner 184 can identify, as the viewing period, a period until the next time when the determiner 184 determines the state of the user U.

Next, the determiner 184 determines whether or not at least one of the one or more display termination conditions associated with the advertisement acquired by the advertisement acquisitor 182 in Step S110 has been satisfied (Step S200). In FIG. 4, the processing of Step S200 is indicated by “HAVE DISPLAY TERMINATION CONDITIONS BEEN SATISFIED?”. Here, details of the one or more display termination conditions associated with an advertisement will be described.

The one or more display termination conditions associated with an advertisement acquired by the advertisement acquisitor 182 in Step S110 include at least one of the following conditions 1 to 3 as the display termination condition, for example.
Condition 1) The total viewing time of the first advertisement by the user U is to be equal to or longer than a first time set in advance.
Condition 2) All of one or more target periods set in advance within the display time of the first advertisement are to be viewed by the user U.
Condition 3) All of one or more target time points set in advance within the display time of the first advertisement are to be viewed by the user U.

The one or more display termination conditions associated with the advertisement acquired by the advertisement acquisitor 182 in Step S110 may be constituted to include one or more other conditions in place of some or all of the foregoing conditions 1 to 3 or in addition to some or all of the foregoing conditions 1 to 3. However, the one or more other conditions are also conditions allowing the advertiser, when at least one of them is satisfied, to acknowledge that the advertisement has been viewed. For example, the one or more other conditions are audio of the first advertisement being output (that is, the volume of audio of the first advertisement is not muted), or the like.

Here, in Step S200, for example, the determiner 184 calculates the time length of each of one or more viewing periods identified by the determiner 184 at the current time. The determiner 184 calculates the sum of the time lengths calculated for each of the one or more viewing periods as the total viewing time of the first advertisement by the user U. Accordingly, in Step S200, the determiner 184 can determine whether or not the foregoing Condition 1 has been satisfied. The first time set in advance may be a part of the display time of the first advertisement or may be the entire display time of the first advertisement. That is, the advertiser of the first advertisement can reliably cause the user U to view at least a part of the first advertisement by associating Condition 1 with the first advertisement as the display termination condition. In other words, the information processing device 1 can reliably cause the user U to view at least a part of the first advertisement by associating Condition 1 with the first advertisement as the display termination condition.

The display time of the first advertisement may be constituted to include one or more weighted periods with which weights different from each other are associated. In this case, the determiner 184 calculates the total viewing time of the first advertisement by the user U on the basis of each of the one or more viewing periods identified by the determiner 184 at the current time and the one or more weighted periods. Accordingly, the information processing device 1 can more reliably cause the user U to view a part of the first advertisement which the advertiser of the first advertisement considers to be highly important. For example, when the display time of the first advertisement is 10 seconds, 5 seconds of the first half of the display time of the first advertisement is a weighted period with which 0.5 is associated as a weight, 5 seconds of the latter half of the display time of the first advertisement is a weighted period with which 2 is associated as a weight, and the viewing period is the entire display time of the first advertisement, the determiner 184 calculates 12.5 seconds as the total viewing time of the first advertisement by the user U through computation of 5 [seconds]×0.5+5 [seconds]×2=12.5 [seconds]. In this case, the advertiser can more reliably cause the user U to view the latter half of the first advertisement by setting the foregoing first time to a time longer than 2.5 seconds.

In addition, in Step S200, for example, the determiner 184 can determine whether or not the foregoing Condition 2 has been satisfied by comparing the one or more viewing periods identified by the determiner 184 at the current time with one or more target periods set in advance within the display time of the first advertisement. The one or more target periods set in advance are periods within the display time of the first advertisement regarded as important by the advertiser who desires to cause the user U to view the first advertisement. That is, the advertiser can reliably cause the user U to view the part of the first advertisement regarded as important by the advertiser by associating Condition 2 with the first advertisement as the display termination condition. In other words, the information processing device 1 can reliably cause the user U to view the part of the first advertisement regarded as important by the advertiser by associating Condition 2 with the first advertisement as the display termination condition.

In addition, in Step S200, for example, the determiner 184 can determine whether or not the foregoing condition 3 has been satisfied by comparing the one or more viewing periods identified by the determiner 184 at the current time with one or more target time points set in advance within the display time of the first advertisement. The one or more target time points set in advance are timings within the display time of the first advertisement regarded as important by the advertiser who desires to cause the user U to view the first advertisement. That is, the advertiser can reliably cause the user U to view the part of the first advertisement regarded as important by the advertiser by associating Condition 3 with the first advertisement as the display termination condition. In other words, the information processing device 1 can reliably cause the user U to view the part of the first advertisement regarded as important by the advertiser by associating Condition 3 with the first advertisement as the display termination condition.

When it is determined that at least one of the one or more display termination conditions associated with the first advertisement has been satisfied (Step S200—YES), the determiner 184 terminates the viewing period identification processing which has started in Step S150 (Step S210). Further, the image capturing controller 185 terminates image capturing by the image capture 17 which has started in Step S130. In addition, the image acquisitor 181 terminates acquisition of a captured image from the image capture 17 which has started in Step S140.

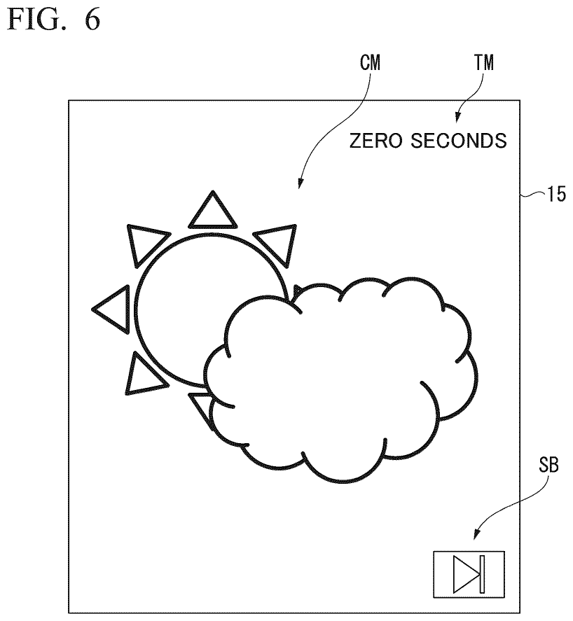

Next, the display controller 183 performs the display termination processing (Step S220). Here, the display termination processing will be described. For example, the display termination processing is processing of causing the display 15 to display an image receiving an operation of terminating display of an advertisement in the display 15. In this case, for example, as shown in FIG. 6, the display controller 183 deletes display of the mark XM superimposed on the foregoing button SB and enables the button SB to receive a selection operation. FIG. 6 is a view showing an example of a situation in which display of the mark XM has been deleted from the video image CM shown in FIG. 5. Here, the example shown in FIG. 6 shows a situation in which the foregoing Condition 1 is satisfied so that display of the mark XM is deleted. For this reason, the information TM indicates “ZERO SECONDS”. In addition, in the example, enabling the button SB to receive a selection operation is indicated as an example of causing the display 15 to display an image receiving an operation of terminating display of an advertisement in the display 15. Instead of this, the display controller 183 may be constituted to cause the display 15 to display a new image receiving an operation of terminating display of an advertisement in the display 15 in the display termination processing of Step S220. In addition, in Step S220, for example, the display controller 183 may be constituted to terminate display of the advertisement in the display 15 without receiving an operation of terminating display of the advertisement in the display 15. In this case, the display termination processing is processing of terminating display of the advertisement in the display 15 without receiving an operation of terminating display of the advertisement in the display 15 (that is, processing of automatically terminating display of the advertisement in the display 15).

Next, the display controller 183 stands by until an operation of terminating display of the advertisement in the display 15 is received (Step S230). In FIG. 4, the processing of Step S230 is indicated by “WISH TO TERMINATE DISPLAY OF ADVERTISEMENT?”. When the display termination processing of Step S220 is the processing of terminating display of the advertisement in the display 15 without receiving an operation of terminating display of the advertisement in the display 15, the processing of Step S230 is omitted.

When it is determined that an operation of terminating display of the advertisement in the display 15 is received (Step S230—YES), the display controller 183 terminates display of the advertisement in the display 15 (that is, display of the first advertisement in the display 15) (Step S240) and terminates the processing of the flowchart shown in FIG. 4. When the display termination processing of Step S220 is the processing of terminating display of the advertisement in the display 15 without receiving an operation of terminating display of the advertisement in the display 15, the processing of Step S240 is omitted.

Meanwhile, in Step S160, when the image analyzer 187 determines that the face of the user U has not been detected from the target captured image (Step S160—NO), the determiner 184 identifies that the state of the user U is the non-viewing state (Step S250). Accordingly, the determiner 184 can identify, as the non-viewing period, a period until the next time when the determiner 184 determines the state of the user U. The determiner 184 may be constituted to identify the viewing period but not identify the non-viewing period.

Next, the display controller 183 and the audio controller 186 pause display of the first advertisement (Step S260). Specifically, in Step S260, the display controller 183 pauses display of the video image of the first advertisement in the display 15. In addition, in Step S260, the audio controller 186 pauses outputting of audio of the first advertisement from the audio output device 16.

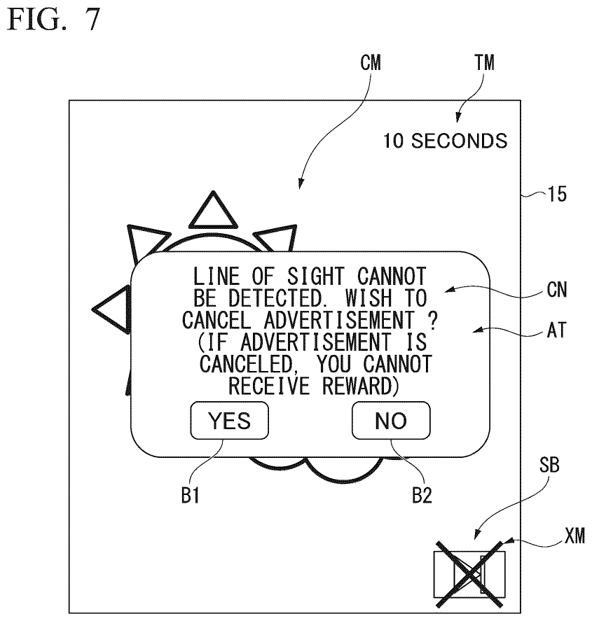

Next, the display controller 183 causes the display 15 to display a viewing promotion image (Step S270). Here, the viewing promotion image is an image including information for prompting the user U to view the first advertisement. FIG. 7 is a view showing an example of a situation of the display 15 displaying a viewing promotion image. An image AT shown in FIG. 7 is an example of a viewing promotion image. The image AT includes information CN, a button B1, and a button B2. The information CN is an example of information for prompting the user U to view the advertisement displayed in the display 15. In the example shown in FIG. 7, the information CN is a character string prompting the user U to view the first advertisement and is a character string of “LINE OF SIGHT CANNOT BE DETECTED. WISH TO CANCEL ADVERTISEMENT?(IF ADVERTISEMENT IS CANCELED, YOU CANNOT RECEIVE REWARD)”. In place of a character string, the information CN may be other kinds of information prompting the user U to view the first advertisement. In addition, the information CN may be audio output from the audio output device 16 in a state in which the image AT is displayed. In this case, this audio is audio prompting the user U to view the advertisement displayed in the display 15. The button B1 is a button receiving an operation of terminating display of the advertisement in the display 15. The button B2 is a button receiving an operation of continuing display of the advertisement in the display 15.

Next, the display controller 183 determines whether or not to terminate display of the advertisement in the display 15 (Step S280). For example, in Step S280, when a selection operation is performed in the button B1 in the image AT shown in FIG. 7 in the viewing promotion image, the display controller 183 determines to terminate display of the advertisement in the display 15. Meanwhile, for example, in Step S280, when a selection operation is performed in the button B2 in the image AT shown in FIG. 7 in the viewing promotion image, the display controller 183 determines not to terminate display of the advertisement in the display 15. The display controller 183 may be constituted to determine, in Step S280, whether or not to terminate display of the advertisement in the display 15 by other methods.

When it is determined to terminate display of the advertisement in the display 15 (Step S280—YES), the display controller 183 terminates display of the first advertisement in the display 15 (Step S290) and terminates the processing of the flowchart shown in FIG. 4.

Meanwhile, when it is determined not to terminate display of the advertisement in the display 15 (Step S280—NO), the display controller 183 and the audio controller 186 restart display of the first advertisement which has been paused in Step S260 (Step S300). Specifically, in Step S300, the display controller 183 restarts display of the video image of the first advertisement in the display 15 which has been paused in Step S260. In addition, in Step S300, the audio controller 186 restarts outputting of audio of the first advertisement from the audio output device 16 which has been paused in Step S260. Further, after the processing of Step S300 is performed, the image analyzer 187 shifts to the processing of Step S160 and acquires a captured image, which has been acquired most recently among captured images acquired by the image acquisitor 181, as the target captured image which will become a target of image analysis. After the target captured image is acquired, the image analyzer 187 performs image analysis of detecting the face of the user U from the target captured image. Further, as a result of this image analysis, the image analyzer 187 determines whether or not the face of the user U has been detected from the target captured image.

Meanwhile, in Step S170, when it is determined that the line of sight direction in which the line of sight of the user U is directed has not been detected from the target captured image (Step S170—NO), the image analyzer 187 determines whether or not the face of the user U is directed to the display screen of the display 15 on the basis of the target captured image (Step S310). Accordingly, even in a state in which the line of sight of the user U cannot be detected from the target captured image due to sunglasses or the like, the information processing device 1 can determine whether or not the state of the user U is the viewing state. The determination method for determining whether or not the face of the user U is directed to the display screen using the image analyzer 187 may be a known method or may be a method to be developed in the future. In addition, in the flowchart shown in FIG. 4, the processing of Step S310 may be omitted. In this case, in Step S170, when it is determined that the line of sight direction in which the line of sight of the user U is directed has not been detected from the target captured image, the determiner 184 shifts to the processing of Step S250 and identifies that the state of the user U is the non-viewing state.

When the image analyzer 187 determines that the face of the user U is directed to the display screen of the display 15 (Step S310—YES), the determiner 184 shifts to the processing of Step S190 and identifies that the state of the user U is the viewing state.

Meanwhile, when the image analyzer 187 determines that the face of the user U is not directed to the display screen of the display 15 (Step S310—NO), the determiner 184 shifts to the processing of Step S250 and identifies that the state of the user U is the non-viewing state.

Meanwhile, in Step S180, when it is determined that the line of sight direction in which the line of sight of the user U is directed is not directed to the display screen of the display 15 (Step S180—NO), the determiner 184 shifts to the processing of Step S250 and identifies that the state of the user U is the non-viewing state.

Meanwhile, in Step S200, when the determiner 184 determines that all of the one or more display termination conditions associated with the first advertisement have not been satisfied (Step S200—NO), the image analyzer 187 shifts to the processing of Step S160 and acquires a captured image, which has been acquired most recently among captured images acquired by the image acquisitor 181, as the target captured image which will become a target of image analysis. After the target captured image is acquired, the image analyzer 187 performs image analysis of detecting the face of the user U from the target captured image. Further, as a result of this image analysis, the image analyzer 187 determines whether or not the face of the user U has been detected from the target captured image.

As above, the information processing device 1 captures an image of the face of the user U looking at the display 15, acquires an advertisement with which one or more display termination conditions for terminating viewing of an advertisement are associated, causes the display 15 to display the acquired advertisement, and determines whether or not the display termination conditions have been satisfied on the basis of a captured image which has been captured when the advertisement is displayed in the display 15. Further, when it is determined that the display termination conditions have been satisfied, the information processing device 1 performs termination processing related to termination of displaying the advertisement in the display 15. Accordingly, the information processing device 1 can more reliably cause a user to view the advertisement displayed in the display 15.

The flowchart shown in FIG. 4 may be constituted to have Step S600 in place of Step S260 to Step S290. In Step S600, the display controller 183 and the audio controller 186 continue display of the first advertisement. In this case, the display controller 183 and the audio controller 186 cause the first advertisement to be repeatedly displayed until the determiner 184 determines that at least one of the one or more display termination conditions has been satisfied since the first advertisement has been displayed in Step S120 in the flowchart. Specifically, in this case, the display controller 183 causes the display 15 to repeatedly display the video image of the first advertisement until the determiner 184 determines that at least one of the one or more display termination conditions has been satisfied since the first advertisement has been displayed in Step S120 in the flowchart. In addition, in this case, the audio controller 186 causes the audio output device 16 to repeatedly output audio of the first advertisement until the determiner 184 determines that at least one of the one or more display termination conditions has been satisfied since the first advertisement has been displayed in Step S120 in the flowchart. Accordingly, in the information processing device 1, it is possible to curb a situation in which the user U feels uncomfortable because the user U is forced to perform an operation of continuing display of the advertisement in the display 15.

### Modification Example 1 of Embodiment

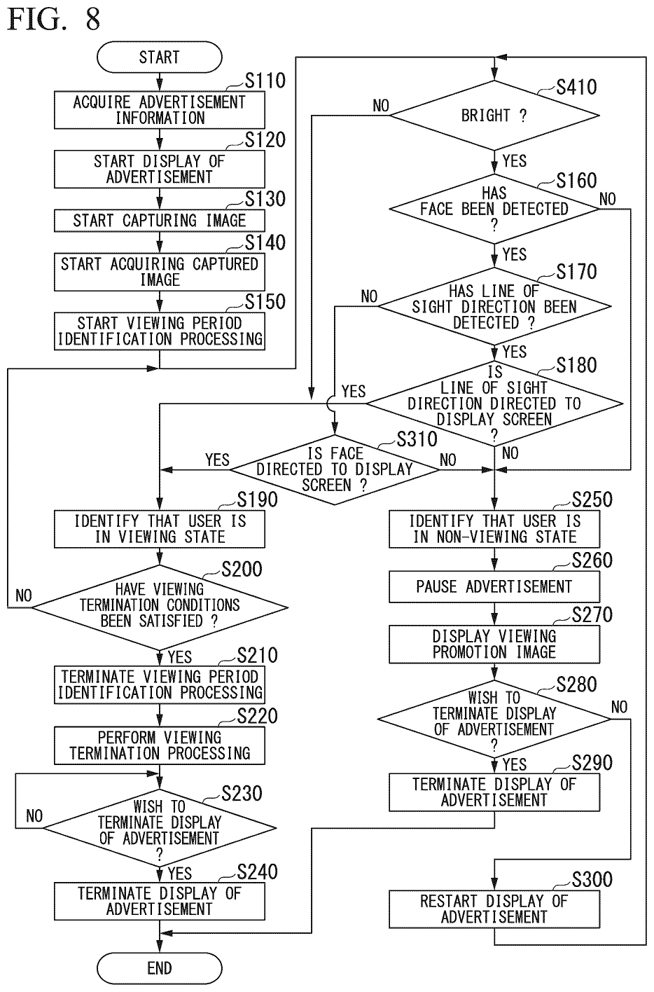

Hereinafter, Modification Example 1 of the embodiment will be described. In Modification Example 1 of the embodiment, the information processing device 1 causes the display 15 to display an advertisement by performing the processing of the flowchart shown in FIG. 8 in place of the flowchart shown in FIG. 4. FIG. 8 is a view showing another example of a flow of the processing in which the information processing device 1 causes the display 15 to display an advertisement. The processing of Step S110 to Step S150 shown in FIG. 8 is processing similar to the processing of Step S110 to Step S150 shown in FIG. 4. In addition, the processing of Step S160 to Step S310 shown in FIG. 8 is processing similar to the processing of Step S160 to Step S310 shown in FIG. 4. For this reason, in FIG. 8, description of each of the processing of Step S110 to Step S150 and the processing of Step S160 to Step S310 will be omitted.

After the processing of Step S150 shown in FIG. 8 is performed, the image analyzer 187 acquires a captured image, which has been acquired most recently among captured images acquired by the image acquisitor 181, as the target captured image which will become a target of image analysis. Further, the image analyzer 187 detects the brightness around the information processing device 1 on the basis of the target captured image. Further, the determiner 184 determines whether or not the brightness detected by the image analyzer 187 is equal to or higher than a first threshold set in advance (Step S410). In FIG. 8, the processing of Step S410 is indicated by “BRIGHT?”. The information processing device 1 may be constituted to include a detector detecting the brightness in place of the constitution detecting the brightness using the image analyzer 187 on the basis of the target captured image, and detect the brightness using the detector. In this case, in Step S410, the determiner 184 determines whether or not the brightness detected by the detector is equal to or higher than the first threshold. For example, the detector is a sensor capable of detecting a brightness, such as a brightness sensor or an illumination sensor, but it is not limited thereto. In addition, for example, the first threshold is the lowest brightness of brightness levels at which the image capture 17 can capture an image of a captured image in which the face of the user U can be detected, but it is not limited thereto. The first threshold may be a brightness higher than the brightness.

When the image analyzer 187 determines that the detected brightness is equal to or higher than the first threshold (Step S410—YES), the determiner 184 shifts to the processing of Step S160 and performs image analysis of detecting the face of the user U from the target captured image. Further, as a result of this image analysis, the image analyzer 187 determines whether or not the face of the user U has been detected from the target captured image.

Meanwhile, when it is determined that the brightness detected by the image analyzer 187 is lower than the first threshold (Step S410—NO), the determiner 184 shifts to the processing of Step S190 and identifies that the state of the user U is the viewing state. Accordingly, even when the area around the information processing device 1 is dark so that the face of the user U cannot be detected, the information processing device 1 can cause the user U to view an advertisement.

In Modification Example 1 of the embodiment, in Step S200 shown in FIG. 8, when it is determined that the one or more display termination conditions have not been satisfied, the determiner 184 shifts to Step S410. In addition, in Modification Example 1 of the embodiment, after the processing of Step S300 shown in FIG. 8 is performed, the determiner 184 shifts to Step S410.

### Modification Example 2 of Embodiment

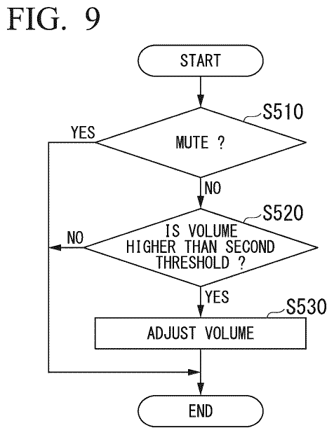

In Modification Example 2 of the embodiment, at a timing after an advertisement viewing start operation is received and at a timing before audio of the first advertisement is output from the audio output device 16 through the processing of Step S120 shown in FIG. 4 or 8, the information processing device 1 executes the processing of the flowchart shown in FIG. 9. FIG. 9 is a view showing an example of a flow of processing of changing the volume of audio when the information processing device 1 displays the first advertisement.

The audio controller 186 determines whether or not the volume of audio output from the audio output device 16 is muted (Step S510). The determination method for determining whether or not the volume of audio is muted using the audio controller 186 may be a known method or may be a method to be developed in the future.

When it is determined that the volume of audio output from the audio output device 16 is muted (Step S510—YES), the audio controller 186 terminates the processing of the flowchart shown in FIG. 9.

Meanwhile, when it is determined that the volume of audio output from the audio output device 16 is muted (Step S510—NO), the audio controller 186 determines whether or not the volume is higher than a second threshold set in advance (Step S520). Here, for example, the second threshold is the lowest volume which can be output by the audio output device 16. The second threshold may be a volume higher than the volume.

When it is determined that the volume of audio output from the audio output device 16 is higher than the second threshold (Step S520—YES), the audio controller 186 adjusts (changes) the volume to a first volume set in advance (Step S530) and terminates the processing of the flowchart shown in FIG. 9. For example, the first volume is the lowest volume which can be output by the audio output device 16. Accordingly, in the information processing device 1, it is possible to curb a situation in which the user U or people around the user U feel uncomfortable with audio of an advertisement. The first volume may be a volume higher than the volume or may be a volume lower than the volume. In this case, in the information processing device 1, audio of the advertisement can be output at a volume desired by the advertiser.

Meanwhile, when it is determined that the volume of audio output from the audio output device 16 is equal to or lower than the second threshold (Step S520—NO), the audio controller 186 terminates the processing of the flowchart shown in FIG. 9.

As above, in the information processing device 1 according to Modification Example 2 of the embodiment, in display of an advertisement, it is possible to curb a situation in which the user U or people around the user U feel uncomfortable with audio of an advertisement. In the flowchart shown in FIG. 9, the processing of Step S520 may be omitted. In addition, it is desirable that the processing of the flowchart shown in FIG. 9 be terminated before the processing of Step S120 shown in FIG. 4 or 8 is performed.

The items described above may be combined in any way.

Hereinabove, an embodiment of this invention has been described in detail with reference to the drawings. However, specific constitutions are not limited to this embodiment and may be changed, replaced, deleted, or the like without departing from the gist of this invention.

In addition, a program for realizing a function of an arbitrary configuration in the device described above may be recorded in a computer-readable recording medium, and the program may be read and executed by a computer system. Here, for example, the device is the information processing device 1 or the like. The said “computer system” includes an OS and hardware such as peripherals. In addition, “a computer-readable recording medium” indicates a portable medium such as a flexible disk, a magneto-optical disc, a ROM, or a compact disk (CD)-ROM, or a storage device such as a hard disk built into a computer system. Moreover, “a computer-readable recording medium” includes those retaining a program for a certain period of time, such as a volatile memory inside a computer system serving as a server or a client when the program is transmitted via a network such as the Internet or a communication line such as a telephone line.

In addition, the foregoing program may be transmitted from a computer system in which this program is stored in a storage device or the like to other computer systems via a transmission medium, or by transmission waves in the transmission medium. Here, “a transmission medium” transmitting a program indicates a medium having a function of transmitting information, such as a network such as the Internet, or a communication line such as a telephone line.

In addition, the foregoing program may be that for realizing some of the functions described above. Moreover, the foregoing program may be that which can realize the foregoing functions in combination with a program which has already been recorded in the computer system or may be a so-called differential file or a differential program.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Information processing device
2 Server
11 Processor
12 Storage
13 Input receiver
14 Communicator
15 Display
16 Audio output device
17 Image capture
18 Controller
181 Image acquisitor
182 Advertisement acquisitor
183 Display controller
184 Determiner
185 Image capturing controller
186 Audio controller
187 Image analyzer
U User

1. An information processing device comprising:
an image capture configured to capture an image of the face of a user looking at a display;
an acquisitor configured to acquire a first advertisement with which one or more display termination conditions for terminating display of an advertisement are associated;
a display controller configured to cause the display to display the first advertisement acquired by the acquisitor; and
a determiner configured to determine whether or not at least one of the one or more display termination conditions has been satisfied on the basis of a captured image captured by the image capture when the first advertisement is displayed in the display,
wherein the display controller is configured to perform termination processing related to termination of displaying the first advertisement in the display when the determiner determines that at least one of the one or more display termination conditions has been satisfied.

2. The information processing device according to claim 1,
wherein the one or more display termination conditions include at least one of:
that a total viewing time of the first advertisement by the user is equal to or longer than a first time set in advance;
that the first advertisement including all of one or more target periods set in advance within a display time thereof has been viewed by the user; and
that the first advertisement including all of one or more target time points set in advance within the display time thereof has been viewed by the user.

3. The information processing device according to claim 1,
wherein the termination processing is any of:
processing of terminating display of the first advertisement in the display, processing of causing the display to display an image receiving an operation of terminating display of the first advertisement in the display; and
processing of enabling an operation to be received in an image receiving an operation of terminating display of the first advertisement in the display.

4. The information processing device according to claim 1,
wherein the determiner is configured to identify a viewing period during which the user has viewed the first advertisement within the display time of the first advertisement on the basis of the captured image when the first advertisement is being displayed in the display, and
wherein the determiner is configured to determine whether or not at least one of the one or more display termination conditions has been satisfied on the basis of the identified viewing period.

5. The information processing device according to claim 4,
wherein the determiner is configured to determine whether or not a line of sight direction in which a line of sight of the user is directed has been directed to a display screen of the display on the basis of the captured image when the first advertisement is displayed in the display, and
wherein the determiner is configured to identify a period during which the line of sight direction is directed to the display screen within the display time of the first advertisement as a period during which the user has viewed the first advertisement.

6. The information processing device according to claim 5,
wherein the determiner is configured to determine whether or not an image of the face of the user has been captured in the captured image on the basis of the captured image when the first advertisement is displayed in the display, and
wherein the determiner is configured to determine whether or not the line of sight direction is directed to the display screen if it is determined that an image of the face of the user has been captured in the captured image.

7. The information processing device according to claim 6 comprising:
a detector configured to detect a brightness in a surrounding area of the information processing device
wherein the determiner is configured to determine whether or not the line of sight direction is directed to the display screen when the first advertisement is displayed in the display and when the brightness detected by the detector is equal to or higher than a threshold set in advance.

8. The information processing device according to claim 1,
wherein the display controller is configured to cause the display to repeatedly display the first advertisement or to cause the display to display an image including information prompting the user to view the first advertisement until the determiner determines that at least one of the one or more display termination conditions has been satisfied when the first advertisement is displayed by the display and when the determiner determines that at least one of the one or more display termination conditions has not been satisfied.

9. The information processing device according to claim 1, further comprising:
an audio output device configured to output audio; and
an audio controller configured to cause the audio output device to output audio,
wherein the audio controller is configured to change a volume of audio output from the audio output device to a first volume set in advance at a timing before the first advertisement is displayed in the display when the display controller causes the display to display the first advertisement.

10. An information processing method for an information processing device including an image capture capable of capturing an image of the face of a user looking at a display, the method comprising:
acquiring a first advertisement with which one or more display termination conditions for terminating display of an advertisement are associated;
causing the display to display the first advertisement acquired in the acquiring step;
determining whether or not at least one of the one or more display termination conditions has been satisfied on the basis of a captured image captured by the image capture when the first advertisement is displayed in the display; and
performing termination processing related to termination of displaying the first advertisement in the display when it is determined in the determining step that at least one of the one or more display termination conditions has been satisfied.

11. A non-transitory processor readable storage medium that stores a processor executable program that is executable by a processor in an information processing device which includes an image capture capable of capturing an image of a face of a user looking at a display, the processor executable program, when executed by the processor, causes the processor to perform a set of operations that comprises:
acquiring a first advertisement with which one or more display termination conditions for terminating display of an advertisement are associated,
causing the display to display the first advertisement acquired in the acquiring step,
determining whether or not at least one of the one or more display termination conditions has been satisfied on the basis of a captured image captured by the image capture when the first advertisement is displayed in the display, and
performing termination processing related to termination of displaying the first advertisement in the display when it is determined in the determining step that at least one of the one or more display termination conditions has been satisfied.
